(19) United States
(12) Patent Application Publication
(10) Pub. No.: US 2026/0237196 A1
(43) Pub. Date: Aug. 13, 2026

(54) CONTENT AUGMENTATION USING FINE-TUNED SMALL LANGUAGE MODELS

(71) Applicant: Microsoft Technology Licensing, LLC, Redmond, WA (US)

(72) Inventors: Biyi FANG, Kirkland, WA (US); Yibo SUN, Bellevue, WA (US); Xiao TU, Medina, WA (US); Mengchen LIU, Redmond, WA (US); Dongdong CHEN, Redmond, WA (US); Victoria Yuantong CHEN, Seattle, WA (US)

(21) Appl. No.: 19/050,826

(22) Filed: Feb. 11, 2025

(51) Int. Cl. G06V 10/82; G06V 10/764; G06V 10/774

(52) U.S. Cl. CPC G06V 10/82; G06V 10/764; G06V 10/774

(57) ABSTRACT

An augmentation service receives a request from a client for a set of actions to suggest with respect to content encoded in an image file included with the request. The service sends a first request to a content generation service to obtain the set of actions, including a first prompt that tasks a small language model (SLM) to generate the set of actions based on the content in the image file. The augmentation service replies to the client with at least a portion of the set of actions. The augmentation service receives, from the client, an indication of a selected action of at least the portion of the set of actions and sends a second request to the content generation service to perform the selected action. The second request includes a second prompt that tasks a large language model (LLM) to perform the selected action.

### TECHNICAL FIELD

Aspects of the disclosure are related to the field of computer hardware and software, and in particular, to content augmentation using small language models.

### BACKGROUND

Content augmentation refers to the process of enhancing or enriching digital content by adding relevant information, suggestions, or actions to improve its value and usability. Many content augmentation services leverage advanced language models to provide meaningful and contextually relevant action suggestions based on the content provided by the user. For instance, if a user selects an action in a user interface to create a chart based on the values in a data table, an LLM may process the selected action and accurately generate the chart.

The user interface menu from which the user selects the action may be populated with action suggestions supplied by the LLM. In such environments, the augmentation service queries the LLM for action suggestions relevant to the type of data object with which the user is interacting. The user interface will then be populated with action suggestions in the LLM's reply. In fact, the prompt that the LLM responds to is designed to suggest actions that are specific to the type of data object being worked on. This ensures that the suggested actions are relevant and tailored to the content and context of the data object.

For example, when working with a word processing document, the LLM might suggest actions such as summarizing the content, extracting key points, or translating the text into another language. On the other hand, when working with a spreadsheet workbook, the LLM might suggest actions like generating charts, performing data analysis, or creating pivot tables.

Unfortunately, when the data object type doesn't align with the content it represents, the LLM might suggest actions that are more relevant to the data object's type rather than its actual content. For instance, if a user is viewing an image of a data table, the language model might suggest actions related to image files, such as editing or enhancing the image, instead of actions relevant to the data table, like generating a chart or performing data analysis. This misalignment can reduce the effectiveness of the language model in providing meaningful and contextually relevant action suggestions.

### SUMMARY

Technology disclosed herein pertains to content generation and processing using advanced language models and computing apparatuses to facilitate efficient data handling and task execution. In various embodiments, an augmentation service implemented in program instructions executed by processing circuitry on a computing platform or apparatus receives a request from a client for a set of actions to suggest with respect to content encoded in an image file included with the request. The service sends a first request to a content generation service to obtain the set of actions, including a first prompt that tasks a small language model (SLM) of the content generation service to generate the set of actions based on the content in the file.

Upon receiving the set of actions from the content generation service, the augmentation service replies to the client with at least a portion of the set of actions. The augmentation service receives, from the client, an indication of a selected action of at least the portion of the set of actions and sends a second request to the content generation service to perform the selected action. The second request includes a second prompt that tasks a large language model (LLM) to perform all or part of the selected action.

Overall, this approach leverages the strengths of both small and large language models, optimizing the system's performance, scalability, and cost-effectiveness. With that said, this Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a computing environment in an implementation, including an augmentation service.

FIGS. 2A-2B illustrate a content augmentation process employed by the augmentation service of FIG. 1 in an implementation.

FIG. 3 illustrates an operational scenario in an implementation with respect to the computing environment of FIG. 1 and the content augmentation process of FIGS. 2A-2B.

FIG. 4 illustrates the training of a small language model in an implementation.

FIG. 5 illustrates a training framework in an implementation.

FIGS. 6A-6E illustrate an image collection in an implementation.

FIGS. 7A-7D illustrate various use cases in an implementation.

FIG. 8 illustrates a user experience in an implementation.

FIG. 9 illustrates another operational scenario with respect to the computing environment of FIG. 1 and the content augmentation process of FIGS. 2A-2B.

FIG. 10 illustrates a computing system suitable for implementing the various operational environments, architectures, processes, scenarios, and sequences discussed below with respect to the other Figures.

### DETAILED DESCRIPTION

The present disclosure relates to content generation and processing using advanced language models and computing equipment to facilitate efficient data handling and task execution. In various implementations, disclosed methods include receiving a request from a client for a set of actions to suggest with respect to content encoded in an image file included with the request. A subsequent request is then sent to a content generation service to obtain the set of actions. This next request includes a first prompt that tasks a small language model of the content generation service to generate the set of actions based on the content in the image file.

Upon receiving the set of actions from the content generation service, a reply is sent to the client with at least a portion of the set of actions. The set of actions may be displayed in a user interface such that a user can select a desired one of the actions. The methods further include receiving, from the client, an indication of a selected action, and sending a request to the content generation service to perform the selected action. This request includes a second prompt that tasks a large language model of the content generation service to perform at least a portion of the selected action.

Using a small language model for the first prompt and a large language model for the second prompt has several advantages and provides various technical effects. For example, small language models are generally faster and require fewer computational resources than large language models. By using a small language model for the initial prompt, the system can quickly generate a set of actions based on the content in the image file, ensuring a prompt response to the client. Small language models may also handle a large number of requests simultaneously, making the system more scalable. This may be particularly important when dealing with high volumes of client requests. By reserving the large language model for the second prompt, the system may allocate its more powerful and resource-intensive capabilities to perform the selected action. This may ensure that the most complex and critical tasks are handled with the highest level of accuracy and sophistication.

Moreover, using a small language model for the initial prompt can reduce operational costs, as it consumes fewer resources. This cost-saving can be significant, especially in large-scale deployments in the cloud or in small-scale deployments implemented locally on user devices. Whereas small language models can be specialized for specific tasks, such as generating a set of actions based on image content, large language models, on the other hand, can handle more complex and nuanced tasks, such as performing the selected action with greater precision. Overall, this approach leverages the strengths of both small and large language models, optimizing the system's performance, scalability, and cost-effectiveness.

The small language model (SLM) is specifically trained using an innovative set of training data generated in a novel manner. This training data includes training image files, each accompanied by action labels that indicate known actions associated with the content encoded in the image file. Additionally, the training data includes actions generated by a large language model based on the training image file and the known actions.

The training process begins with classifying a set of training images based on their content and identifying known actions based on these classifications. The known actions are then used as seeds in prompts to a large language model, which generates additional actions based on the seed actions. The combined set of known and additional actions for each training image forms a portion of the training data used to train the SLM.

The SLM includes an artificial neural network, and its training involves several steps. First, feature vectors are generated based on image data in the training image files. These feature vectors represent various aspects of the image content, such as shapes, colors, and patterns. The feature vectors are supplied as input to the neural network, which processes them to obtain predicted actions as outputs. The weights of the neural network are modified based on comparisons of the predicted actions to the action labels for each training image file. This is done through a process called backpropagation, where the network adjusts its weights to minimize the difference between the predicted actions and the actual action labels. Over time, this iterative process helps the neural network learn to make more accurate predictions.

Additionally, the training of the SLM involves concepts like tokens and token sequences, which are fundamental to generative artificial intelligence technology such as the SLM. Tokens are the basic units of text, such as words or sub words, that the model processes. During training, the SLM learns to predict the next token in a sequence based on the context provided by the preceding tokens. This process, known as token prediction, ensures that the SLM can generate accurate and contextually relevant actions based on the content within images. The use of tokens and token sequences allows the model to capture the intricate details and relationships within the image data, leading to more precise and meaningful predictions. This comprehensive approach ensures that the SLM is well-trained to predict relevant actions based on the content within images, optimizing the system's performance, scalability, and cost-effectiveness.

In a brief operational example, the augmentation service receives a request from a client that includes an image of a data table captured in an image file. The augmentation service processes the image file and generates a set of suggested actions using a small language model. For instance, the small language model analyzes the visual elements and context of the table. The SLM then predicts relevant actions, such as generating a corresponding table in a spreadsheet, creating a chart based on the values in the data table, and summing the numbers in each column of the data table. These suggested actions are surfaced in a user interface, allowing the user to review and select one of the actions.

Once the user selects an action, the augmentation service utilizes a large language model to perform the selected action with respect to the content in the image. In this example, if the user selects the action to create a chart based on the values in the data table, the large language model processes the selected action and accurately generates the chart.

In another example, the augmentation service receives a request from a client that includes an image of a phone number captured in an image file. The augmentation service processes the image file and generates a set of suggested actions using a small language model. For instance, the small language model analyzes the visual elements and context of the phone number and then predicts relevant actions, such as initiating a call using the phone number, creating a new contact with the phone number, and sending a text message to the new phone number. These suggested actions are surfaced in a user interface, allowing the user to review and select one of the actions. Once the user selects an action, the augmentation service utilizes a large language model to perform the action with respect to the content in the image. In this example, if the user selects the action to create a new contact with the phone number, the large language model processes the selected action and accurately creates the new contact.

Other use cases include document analysis, where the content within the image includes a scanned document. The small language model can suggest actions such as extracting text from the document, summarizing the content, and translating the text into another language. Once the user selects an action, the large language model can perform the selected task, such as translating the document into the desired language. Similarly, if the content within the image includes a product label, the small language model can suggest actions such as retrieving product details, comparing prices with other retailers, and checking for customer reviews. After the user selects an action, the large language model can execute the task, such as retrieving and displaying customer reviews for the product.

In the context of event planning, if the content within the image includes an event flyer, the small language model can suggest actions such as adding the event to a calendar, setting a reminder for the event, and sharing the event details with contacts. Once the user selects an action, the large language model can perform the task, such as adding the event to the user's calendar with a reminder. For recipe suggestions, if the content within the image includes a list of ingredients, the small language model can suggest actions such as generating recipe ideas, creating a shopping list for missing ingredients, and providing cooking instructions. After the user selects an action, the large language model can execute the task, such as generating a detailed recipe based on the ingredients.

Lastly, in the context of travel planning, if the content within the image includes a travel itinerary, the small language model can suggest actions such as booking accommodations, finding local attractions, and creating a travel schedule. Once the user selects an action, the large language model can perform the task, such as booking a hotel room based on the itinerary. These examples demonstrate the versatility and practicality of the augmentation service in various scenarios, providing users with meaningful and contextually relevant actions while ensuring precise execution of the selected tasks.

The augmentation service may be designed to interface seamlessly with clients on various user devices, such as mobile phones, laptops, or similar devices. When a user interacts with the service, their device sends a request to the augmentation service, which runs in the cloud on servers and other such equipment. This cloud-based infrastructure ensures that the service can handle a large number of requests simultaneously and provide quick responses to users.

The content generation service, which hosts both the small language model (SLM) and the large language model (LLM), also operates in the cloud. When the augmentation service receives a request from a client, it processes the image file and generates a set of suggested actions using the SLM. These suggested actions are then surfaced in a user interface on the client's device, allowing the user to review and select one of the actions.

Once the user selects an action, the augmentation service utilizes the LLM to perform the selected action with respect to the content in the image. The LLM, with its advanced capabilities, processes the selected action and executes it accurately and efficiently. This cloud-based architecture ensures that the system can leverage the powerful computational resources required for training and running the SLM and LLM, while providing users with a seamless and responsive experience on their devices.

In an alternative implementation, the small language model (SLM), the augmentation service, and even the large language model (LLM) could be deployed locally on the client device, such as a mobile phone, laptop, or similar device. This approach offers several advantages, including reduced latency, increased privacy, and offline functionality.

When the SLM is implemented locally, the client device can process the image file and generate a set of suggested actions without needing to communicate with cloud-based servers. This reduces the time it takes to generate and display the suggested actions in the user interface, providing a more responsive experience for the user. Additionally, since the data remains on the client device, this approach can enhance privacy by minimizing the need to transmit sensitive information over the internet.

Similarly, if the augmentation service runs locally on the client device, it can manage the interaction between the user and the SLM, as well as the execution of the selected actions. This local implementation ensures that the entire process, from generating suggested actions to performing the selected actions, can be completed without relying on cloud-based services. Furthermore, deploying the LLM locally on the client device allows the device to perform complex tasks and execute the selected actions with respect to the content in the image. This can be particularly beneficial in scenarios where internet connectivity is limited or unavailable, as the device can still provide meaningful and contextually relevant actions based on the content within images. Overall, implementing the SLM, augmentation service, and LLM locally on the client device offers a robust and efficient alternative to cloud-based deployment, providing users with a seamless and responsive experience while enhancing privacy and enabling offline functionality.

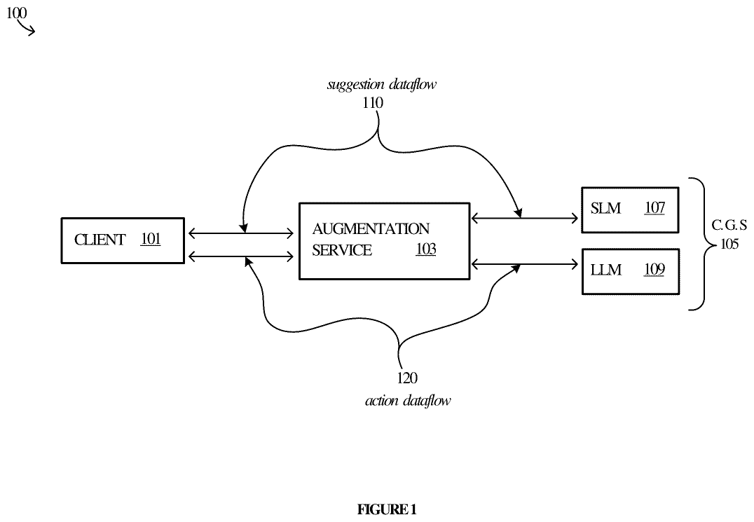

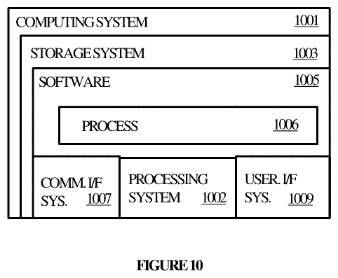

FIG. 1 illustrates system 100 in an implementation. System 100 provides a comprehensive framework for content generation and processing, integrating various components to facilitate efficient data handling and task execution. System 100 includes client 101, augmentation service 103, and content generation service 105 (CGS). Content generation service 105 includes SLM 107 and LLM 109. Client 101, augmentation service 103, SLM 107, and LLM 109 may each be implemented in computing software on a suitable computing device or devices (e.g., computing device 1001 in FIG. 10) either separately or in an integrated manner. For example, client 101 may be implemented on a user device such as a mobile phone, laptop, or similar device. Augmentation service 103 may be implemented on computing equipment remote from client 101, on the same device as client 101, or distributed amongst both. SLM 107 may also be implemented remotely from client 101, locally with respect to client 101, or both. LLM 109 may also be implemented locally with respect to client 101, remotely, or both.

Client 101 is representative of one or more software components capable of interfacing with augmentation service 103. Examples include software applications such as mobile applications, desktop applications, web applications, add-in components of such applications, and the like. Client 101 may interact with other resources such as operating system components to facilitate communications with augmentation service 103. In some cases, client 101 may itself be an operating system component or other such intermediary application that facilitates interactions between other applications (e.g., mobile, desktop, or web applications) and augmentation service 103.

Augmentation service 103 is representative of one or more software components capable of coordinating various types of data and services across different applications. In particular, augmentation service 103 enhances the capabilities of client 101 by integrating advanced language models and other tools to provide meaningful and contextually relevant action suggestions. As mentioned, augmentation service 103 may be implemented remotely or locally with respect to client 101, or both. For example, augmentation service 103 may run entirely on a server or collection of servers remote from a device that hosts client 101, on the same device as client 101, or distributed amongst both the server(s) and the device.

Content generation service 105 refers to a collection of software resources that may be integrated into application ecosystems and environments to enhance their capabilities. Example resources include data repositories and graphs, security services, natural language processing capabilities, and generative artificial intelligence resources such as SLM 107 and LLM 109. Content generation service 105 provides unified endpoint access to such resources via application programming interfaces (APIs) and/or data connectors that may be integrated into the components of said application ecosystems and environments. For example, augmentation service 103 may communicate with content generation service 105 via specific APIs that allow it to interact with SLM 107 and LLM 109. As mentioned, content generation service 105 may be implemented remotely or locally with respect to client 101, or both. For example, content generation service 105 may run entirely on a server or collection of servers remote from a device that hosts client 101, on the same device as client 101, or distributed amongst both the server(s) and the device. Thus, SLM 107 may be implemented locally or remote from client 101, or distributed both locally and remotely, and LLM 109 may be implemented locally or remote from client 101, or in a distributed manner.

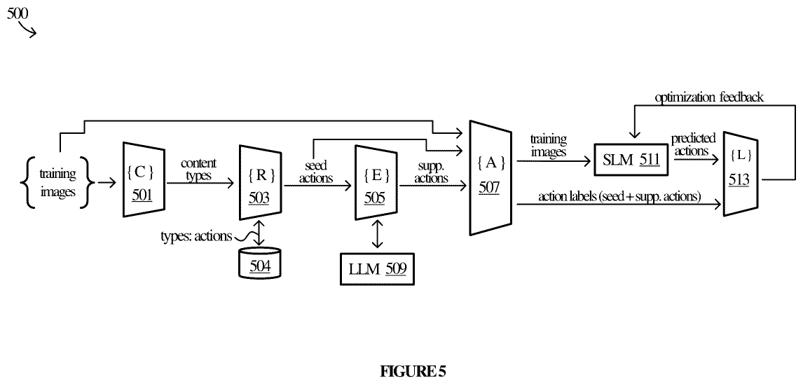

SLM 107 is a type of artificial neural network fine-tuned to process and analyze specific types of content, such as text or images to provide relevant action-suggestions. SLMs are typically smaller in size and complexity compared to large language models (LLMs), making them more efficient and faster to run. SLM 107 may be implemented using the Phi-3 family of models (e.g., MM-Phi), MiniLM models, or any other suitable family of models designed to be efficient and cost-effective while providing high-quality results. SLM 107 is trained in a specific manner described below with respect to FIG. 5.

LLM 109 is a large language model designed to enhance the capabilities of software applications by leveraging advanced natural language processing techniques. LLM 109 may be integrated into an application ecosystem to provide intelligent assistance, generate contextually relevant responses, and improve overall user productivity. Examples of LLM 109 include pretrained models such as Generative Pre-Trained Transformers (GPT) (e.g., GPT-4), LLaMA 2, Claude 2, and PaLM 2.

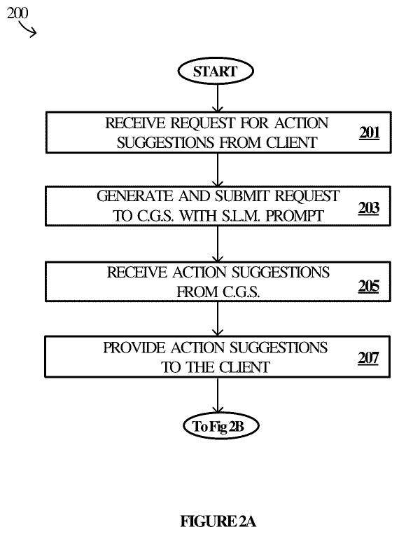

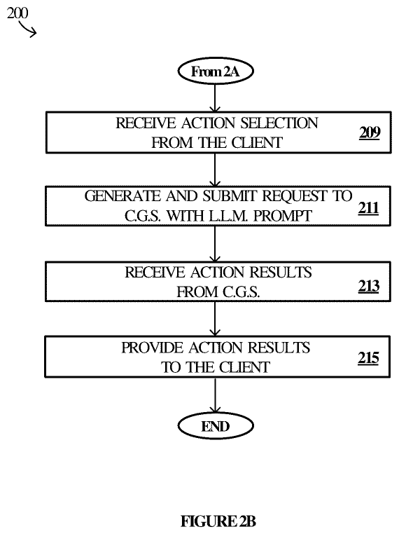

Augmentation service 103, in cooperation with client 101 and content generation service 105, employs a content augmentation process 200 illustrated in FIGS. 2A-2B to augment image data supplied by client 101. The first portion of content augmentation process 200 illustrated in FIG. 2A corresponds to a suggestion workflow 110 amongst client 101, augmentation service 103, and SLM 107. A second portion of content augmentation process 200 illustrated in FIG. 2B corresponds to action workflow 120 amongst client 101, augmentation service 103, and LLM 109. Content augmentation process 200 may be implemented in program instructions in the context of the software and/or firmware elements of augmentation service 103. The program instructions, when executed by one or more processing devices of one or more suitable computing devices, direct the one or more computing devices to operate as follows, referring to the steps of FIG. 2 and in the singular to a computing device for the sake of clarity.

In operation, the computing device receives a request from a client for a set of actions to suggest with respect to content encoded in an image file included with the request (step 201). The computing device sends a first request to a content generation service to obtain the set of actions, including a first prompt that tasks a small language model of the content generation service to generate the set of actions based on the content in the image file (step 203). The SLM, per the prompt, processes the image file and returns a set of suggested actions (or action suggestions).

The computing device receives the set of suggested actions (step 205) and, upon receiving them, provides at least a portion of the set of actions to the client to be displayed in a user interface (step 207). In this manner, the computing device causes or otherwise enables display of the suggested actions in the user interface. A user, agent, or other such entity associated with the client makes a selection from the action suggestions and the client communicates the selected action to the computing device. The computing device receives, from the client, an indication of the selected action (step 209).

The computing device then generates and sends a request to an LLM to perform the selected action (step 211). The request includes the image file and a prompt directing the LLM to perform the selected action with respect to content encoded in the image data of the image file. The LLM, per the prompt, processes the image data to perform at least a portion of the action and returns the results to the computing device. The computing device receives the “action results” (step 213) and provides the results to the client.

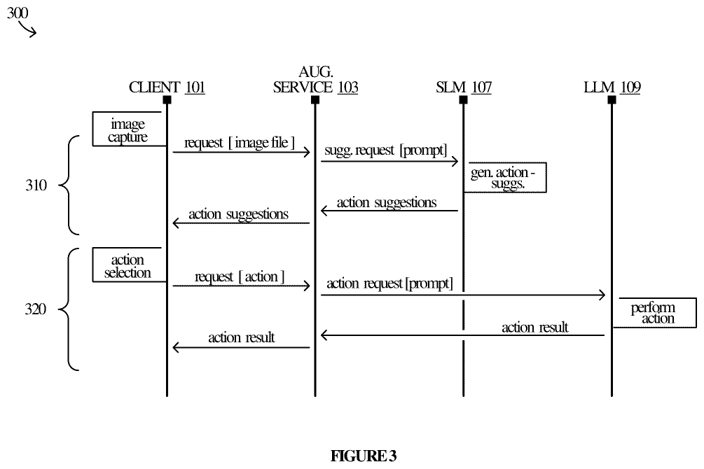

FIG. 3 illustrates operational scenario 300, which depicts an application of content augmentation process 200 with respect to the elements and dataflows of system 100 in FIG. 1. The first portion 310 of operational scenario 300 corresponds to suggestion workflow 110, while a second portion 320 of operational scenario 300 corresponds to action workflow 120.

In operation, image capture is performed by or in association with client 101. For example, a user operating a client device may capture an image of a physical object such as a paper receipt, take a screenshot of a displayed image, or the like. The image is encoded in image data in accordance with an image file format (e.g., JPEG, PNG, GIF, BMP, and SVG). The user then interacts with client 101 via a user interface to obtain actions suggestions with respect to the image content. For instance, the user may interact with menu options in the user interface to attach or otherwise associate the image file with a request for action suggestions. Client 101 responsively generates an associated request and sends the request to augmentation service 103. The request includes the image file and is directed to an API of augmentation service 103 that triggers workflow 110.

Augmentation service 103 receives the request and responsively generates a suggestion request for content generation service 105. Augmentation service 103 directs the suggestion request to an API of content generation service 105 corresponding to SLM 107. The suggestion request includes the image file and a prompt that directs SLM 107 to provide action suggestions relevant to the content encoded in the image data of the image file. SLM 107 responds to the API call by processing the image data to generate action suggestions for enhancing or otherwise augmenting the image content. SLM 107 generates the actions suggestions and returns them to augmentation service 103. In turn, augmentation service 103 replies to client 101 with the action-suggestions.

Client 101 receives the action suggestions from augmentation service 103 and displays the suggestions in the user interface on the host computing device. The user operating the device is able to consider the suggestions and select a preferred one from the user interface. Once a suggested action is selected, client 101 communicates a new request to augmentation service 103 that indicates the selected action. In response, augmentation service 103 generates an action request for content generation service 105. The action request is an API call corresponding to LLM 109 and includes both an indication of the selected action and the image file. For instance, the call includes a prompt that directs LLM 109 to perform the selected action with respect to the content encoded in the image file.

LLM 109 responds to the prompt by processing the image file in furtherance of the requested action. In an example, the prompt may task LLM 109 with generating a spreadsheet table corresponding to a data table captured in the image file. In another example, the prompt may task LLM 109 with creating a contact for a phone number captured in the image file. LLM 109 performs at least a portion of the requested action and returns the augmented content to augmentations service 103. Augmentation service 103 then provides the results to client 101 for display in its user interface and/or for further processing.

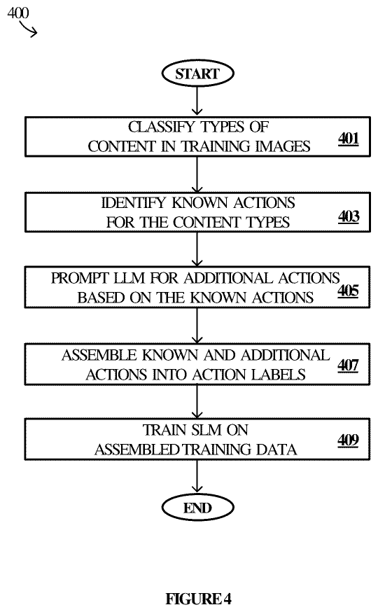

FIG. 4 illustrates a process for training SLM 107 in an implementation. Training process 400 may be implemented in program instructions in the context of the software and/or firmware elements of a suitable training framework. The program instructions, when executed by one or more processing devices of one or more suitable computing devices, direct the one or more computing devices to operate as follows, referring to the steps of FIG. 4 and to a training framework for the sake of clarity.

To begin, the framework identifies target content in the images of a set of training files and classifies the content type of each of the images (step 401). This may involve, for example, performing object and/or entity recognition analysis on each image in the set using Convolutional Neural Networks (CNNs) and the like to extract features from images, such as edges, textures, and shapes, and classify a given image as having content encoded therein of one specific type or another. For instance, images may be classified into content categories such as text documents, email and messaging content, web browsing content, social media content, spreadsheet and tabular data content, presentation content, video meeting content, video streaming content, photos and camera content, graphic design content, code editing content, gaming content, navigation (map) content, e-commerce content, health and food content, handwritten notes content, math content, and so on.

A neural network employed to perform Step 401 may itself be trained on a set of images labeled as belonging to one or more of the content types described above such that it is able to classify new training images by their content types. In some implementations, Step 401 may be skipped if a suitable set of training images exists and/or may be obtained that includes images that are already labeled with their content types. In still other implementations, a combination of both approaches may be employed whereby some of the training images are pre-labeled with their content types, while others of the training images are not yet labeled as such.

Having identified and/or obtained a set of training images labeled by content type, the framework proceeds to identify known actions for each of the training images based on their respective content type (step 403). For example, for text documents, the known actions may include extracting text, summarizing content, converting to PDF, translating text, and searching for keywords. Email and messaging content actions may include extracting contact information, setting a reminder, and scheduling a meeting. Actions for web browsing content may include creating a bookmark, saving for later, and extracting key information. Actions for social media may include analyzing for engagement and monitoring for mentions. Spreadsheet and tabular data content actions may include charting, filtering, and sorting. Presentation content actions may include converting to PDF and generating notes. Actions for video meeting content may include recording, transcribing, and scheduling a follow up meeting. Actions for video streaming content may include book marking a video stream, adding a video stream to a playlist, and analyzing a video stream for viewing patterns. Photos and camera content actions may include organizing, filtering, and performing facial recognition. Code editing content actions may include analyzing syntax, debugging, and version analysis. Gaming content actions may include recording, streaming, and analyzing for performance. Navigation (map) content actions may include planning a trip, calculating a distance, and updating for real-time traffic. E-commerce content actions may include tracking, comparing prices, and creating an inventory. Health and food content actions may include tracking for nutrition, meal planning, and health metric monitoring. Actions for handwritten notes content may include converting to text, organizing, and searching for keywords. Math content actions may include solving equations, graphing, and providing step-by-step solutions.

Next, the framework generates and sends a prompt to an LLM that tasks the LLM with generating additional actions for each of the content types (step 405). The prompt includes, for a given type of content, the known actions determined for that content type. A single prompt may be generated that includes all of the identified content types and their corresponding known actions. Alternatively, multiple prompts may be generated. For instance, an individual prompt may be generated for each individual content type. In another alternative, a single prompt may include a subset of the content types and the corresponding known actions for the content types in the subset. Thus, multiple prompts-each including a subset of the content types-may be generated and employed.

Regardless of the number of prompts used, any given prompt includes at least an indication of one or more content types and the known actions determined for each of the content types. Furthermore, the prompts include instructions for the LLM to generate additional actions for a given content type using the known actions as seeds. For example, for the text document content type, the prompt may identify known actions including extracting text, summarizing content, converting to PDF, translating text, and searching for keywords. The prompt would also task the LLM with identifying additional actions based on the known actions determined for the text document content type. In another example involving email and messaging content types, the prompt may identify known actions such as extracting contact information, setting a reminder, and scheduling a meeting. The prompt would also task the LLM with identifying additional actions based on the actions known for the email and messaging content types. The known actions determined or otherwise identified in step 403 function as “seed actions” that cause or influence the LLM to predict new actions that supplement the known actions.

The following actions are provided for exemplary purposes as representative of supplemental actions that the LLM may provide in reply to the prompts discussed above, with respect to the content types discussed above. For example, for text documents, the supplemental actions may include extracting metadata (e.g., author and date), detecting plagiarism, annotating text, and generating summaries in different languages. For emails and messaging content types, the supplemental actions may include categorizing emails, detecting sentiment, extracting attachments, and generating automated responses. For web browsing content, the supplemental actions may include archiving web pages, translating web pages, detecting changes on web pages, and extracting structured data (tables, lists). For social media content, the supplemental actions may include scheduling posts, analyzing sentiment, identifying influencers, and tracking hashtags. For spreadsheet and tabular data content, the supplemental actions may include validating data, merging datasets, generating pivot tables, and performing statistical analysis. For presentation (slide) content, the supplemental actions may include adding animations, converting to video, collaborating in real-time, and generating speaker notes. For video meetings, the supplemental actions may include highlighting key moments, generating action items, and analyzing participant engagement. For video streaming, the supplemental actions may include generating transcripts, recommending similar content, analyzing viewer demographics, and creating highlight reels. For photos and camera content, the supplemental actions may include enhancing image quality, detecting objects, creating slideshows, and tagging locations. For code editing content, the supplemental actions may include refactoring code, generating documentation, running unit tests, and integrating with version control. For gaming content, the supplemental actions may include analyzing gameplay statistics, generating walkthroughs, customizing controls, and monitoring for cheating. For navigational and map content, the supplemental actions may include finding points of interest, sharing location information, estimating travel time, and providing alternate routes. For e-commerce content, the supplemental actions may include generating sales reports, managing customer reviews, recommending products, and tracking shipments. For health-type content, the supplemental actions may include suggesting recipes, tracking exercise, monitoring hydration, and providing dietary recommendations. For handwritten content such as notes, the supplemental actions may include detecting a handwriting style, converting to diagrams, sharing notes, and integrating with digital calendars. For math content, the supplemental actions may include simplifying expression, converting units, generating practice problems, and visualizing data.

The known and additional actions are then assembled by the framework into action labels for each image in the training set (step 407). The training data thus assembled includes the set of image files—each made of image data having content encoded therein—and a set of action labels corresponding to each individual image file. For instance, for each individual image file in the training set, the training data will include multiple action labels for the image file. The action labels for the image file will include text strings descriptive of of the known actions determined for the type of content encoded in the image data of the image file, as well as textual descriptions of the additional (or supplemental) actions supplied by the LLM.

At step 409, the framework trains an SLM using the assembled training data. Training the SLM may include, for example, supplying image data as input to the SLM to generate predicted actions associated with the content encoded in the image data. The predictions output by the SLM may then be evaluated against the ground-truth action labels associated with the image file from which the image data was drawn. That is, for each image file in the training data, its image data is input into the SLM, and a loss function of the SLM (or its associated training environment) compares actions output by the SLM to the action labels associated with the image file. Weights and other parameters of the SLM may be adjusted accordingly until it is sufficiently performant with respect to generating suggested actions.

FIG. 5 illustrates a training framework 500 that is representative of a framework suitable for training an SLM as discussed above with respect to FIG. 4. Training framework 500 includes a classifier function 501, a refiner function 503, an enhancement function 505, an assembler function 507, an SLM 511, and a loss function 513. It may be appreciated that training framework 500 is a highly simplified representation of a suitable training framework whose purpose is to highlight certain aspects of the training process and is not intended to exclude other functions or elements.

Classifier function 501 is representative of any software and/or firmware component(s) capable of performing step 401 in training process 400, including identifying target content in the images of a set of training files and classifying the content type of each of the images. This may involve performing object and/or entity recognition analysis on each image using Convolutional Neural Networks (CNNs) to extract features such as edges, textures, and shapes, and classify the image into specific content categories.

Refiner function 503 is representative of any software and/or firmware component(s) capable of performing step 403 above, including identifying known actions for each of the training images based on their respective content type. For example, known actions for text documents may include extracting text, summarizing content, converting to PDF, translating text, and searching for keywords. Refiner function 503 may access a datastore 504 that holds a list of content types and their known corresponding actions. The information in datastore 504 may be collected a-priori and/or generated at runtime.

Enhancement function 505 is representative of any software and/or firmware component(s) capable of performing step 405, including generating and sending a prompt to a large language model (LLM) 509 to generate additional actions for each content type. The prompt may include the known actions determined for each content type, and the LLM 509 generates supplemental actions based on these known actions.

Assembler function 507 performs step 407, including assembling the known and additional actions into action labels for each image in the training set. The training data thus assembled includes the set of image files and a set of action labels corresponding to each individual image file.

SLM 511 and loss function perform Step 409, which involves training the SLM using the assembled training data. SLM 511 generates predicted actions associated with the content encoded in the image data, and loss function 513 compares these predicted actions to the action labels associated with the image file. A backpropagation process may adjust the weights and possibly other parameters of SLM 511 based on the output of loss function 513.

SLM 511 includes an artificial neural network, and training SLM 511 further involves generating feature vectors based on image data in the training image files. These feature vectors represent various aspects of the image content, such as shapes, colors, and patterns. The feature vectors are supplied as input to the neural network, which processes them to obtain predicted actions as outputs. The weights of the neural network are modified based on comparisons of the predicted actions to the action labels for each training image file through a process called backpropagation.

Additionally, the training of SLM 511 involves tokens and token sequences. Tokens are the basic units of text that the model processes. During training, SLM 511 learns to predict the next token in a sequence based on the context provided by the preceding tokens. This process ensures that SLM 511 can generate accurate and contextually relevant actions based on the content within images. The use of tokens and token sequences allows the model to capture the details and relationships within the image data, leading to precise and meaningful predictions.

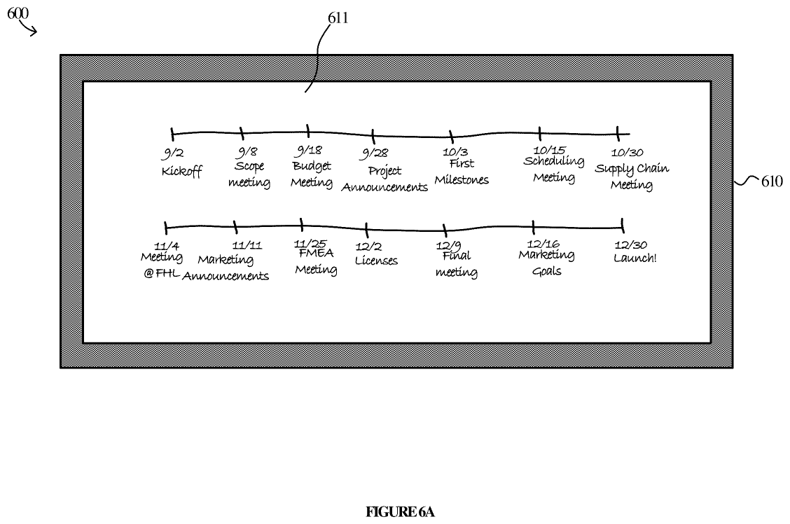

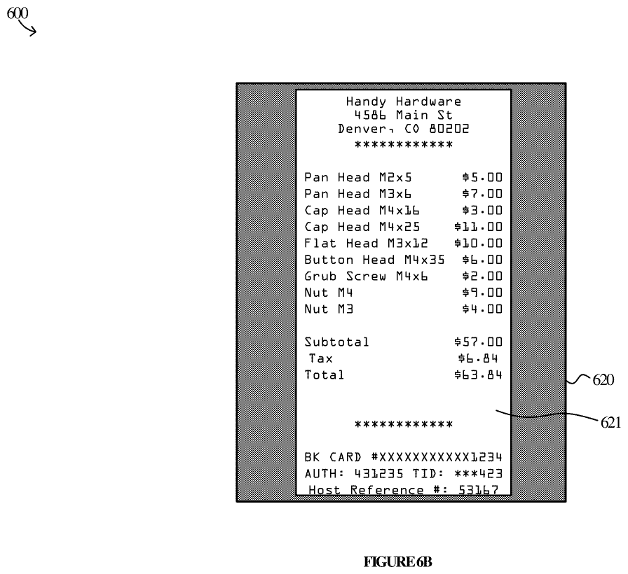

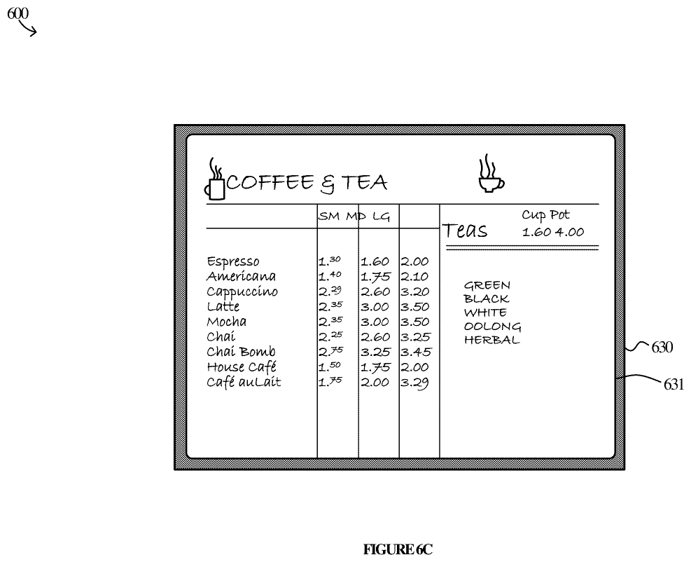

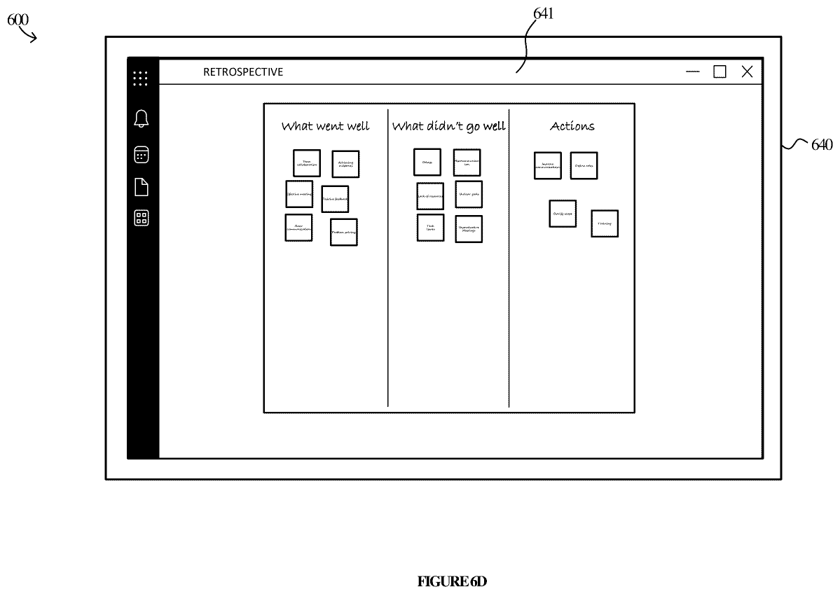

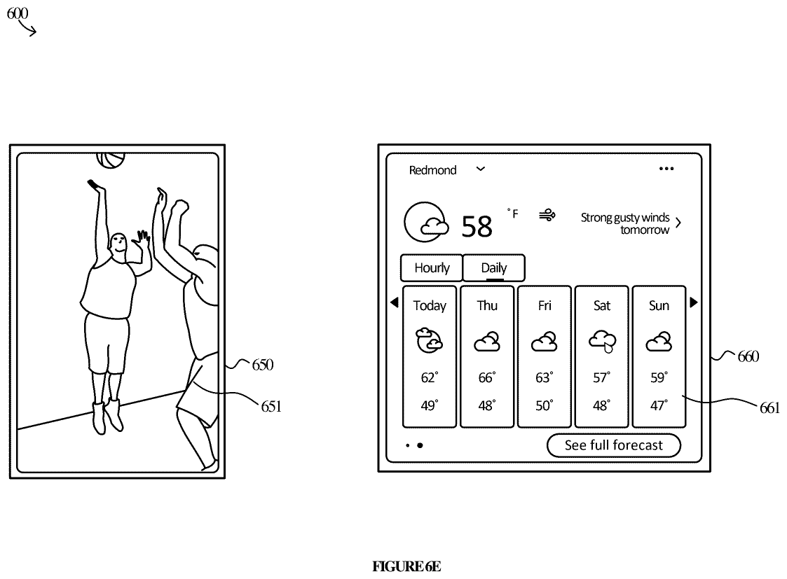

FIGS. 6A-6E illustrate a collection 600 of images that are representative of the images, image files, and image data discussed herein. Collection 600 includes image 610 in FIG. 6A, image 620 in FIG. 6B, image 630 in FIG. 6C, image 640 in FIG. 6D, and image 650 and image 660 in FIG. 6E. Each image may be generated from image data in an image file, in which content captured by a camera or other such device, or generated synthetically, is encoded. The image data may be processed by a computing device to render the images on a display screen. The images in collection 600 are representative of data that may be suitable for training an SLM as described above. Additionally, or alternatively, the images in collection may be representative of the types of images that may be augmented at runtime as discussed above.

Image 610 includes image content 611, which in this example is a hand-drawn timeline. Image 620 includes image content 621, which is a paper receipt. Image 630 includes image content 631, which is a restaurant menu. Image 640 includes image content 641, which is a digital white board screen shot. Image 650 includes image content 651, which is a photo of a live action moment. Image 660 includes image content 661, which is a digital screen shot of a weather forecast. The content types associated with these images may include, for example, hand-written or hand-drawn notes, a timeline, paper receipts, menus, digital white boards, live action moments, weather forecasts, and the like. The content types may be used to fine-tune an SLM in the context of a training framework. Additionally, or alternatively, the content types may be identified by an SLM to enhance the subsequent prompts sent to an LLM to provide suggested actions.

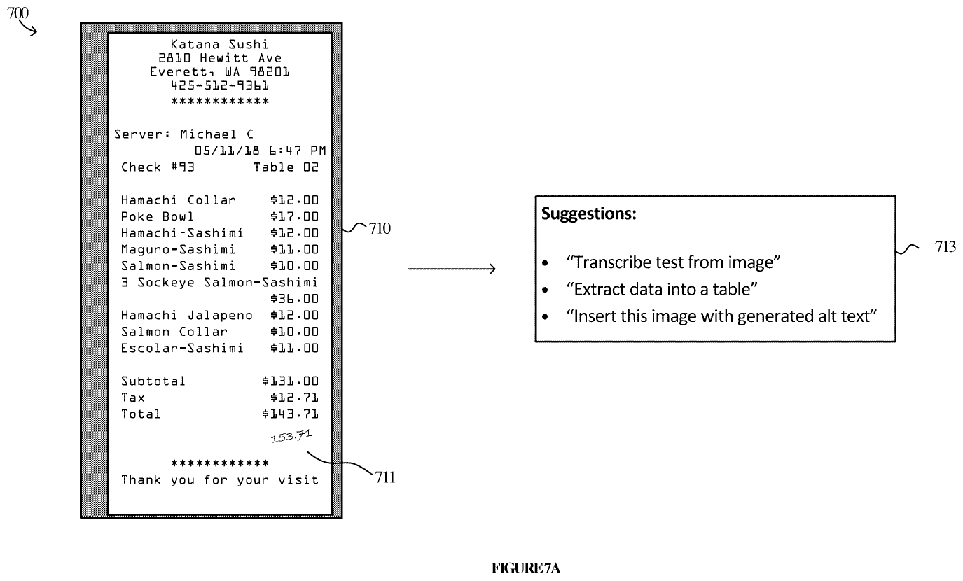

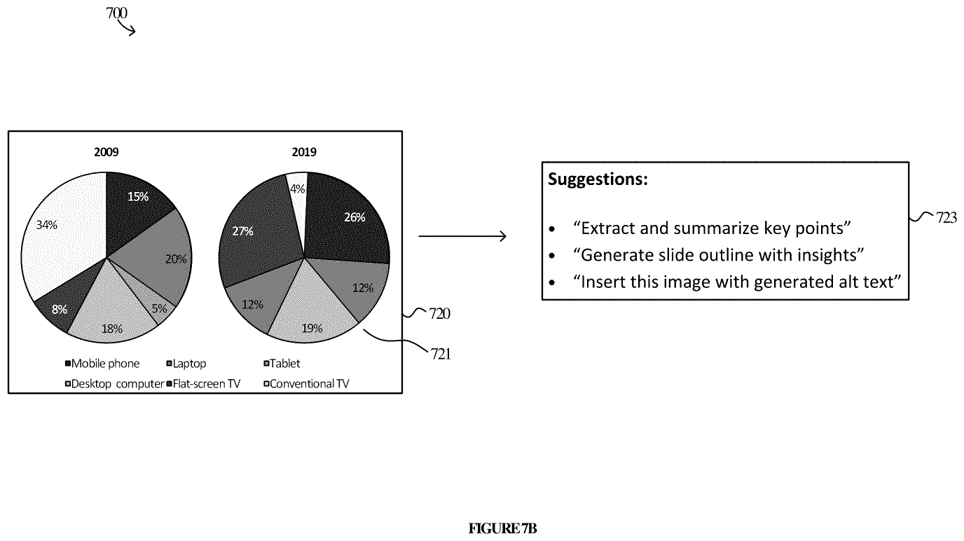

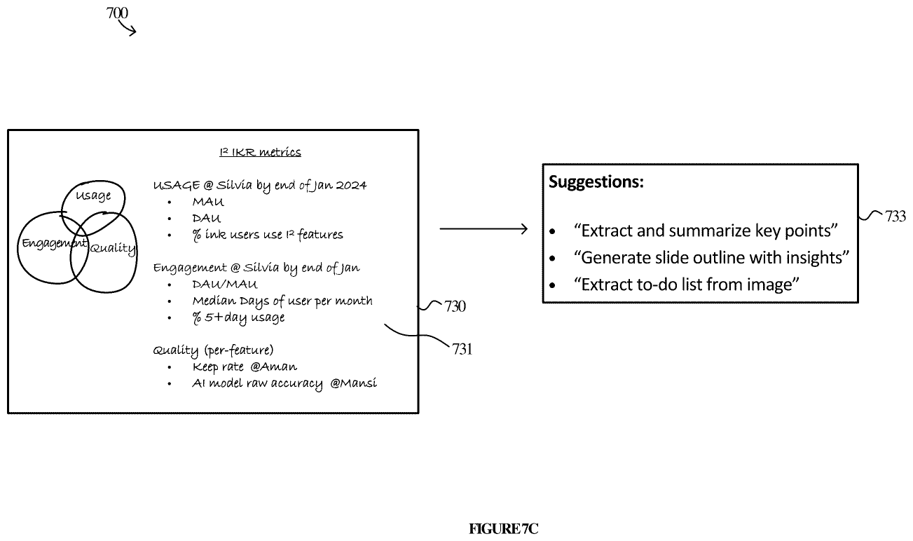

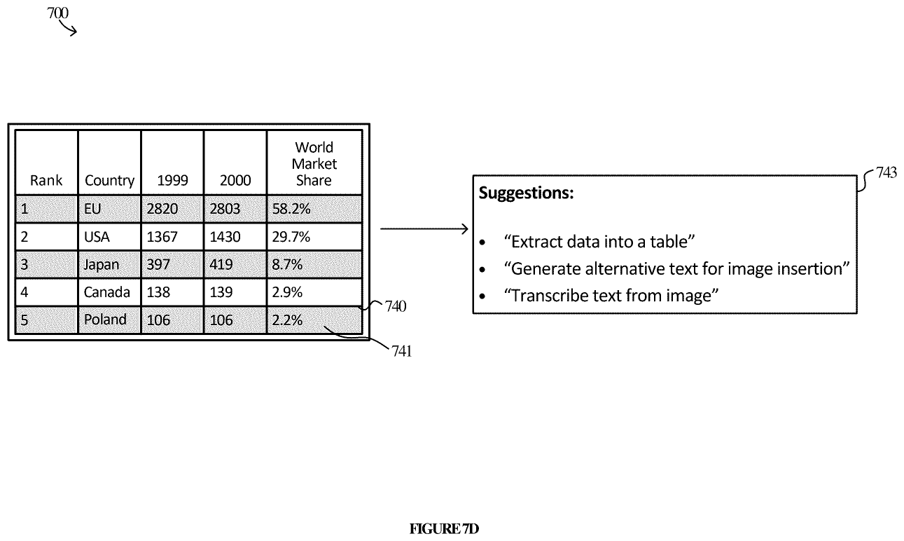

FIGS. 7A-7B illustrate various use-cases 700 of the content augmentation technology disclosed herein. In FIG. 7A, image 710 includes a visual representation 711 of a paper receipt. Supplying the corresponding image file, having image 710 encoded therein, as input to an augmentation service as disclosed herein (e.g., augmentation service 103), results in a list of action suggestions 713 that are contextually relevant to the receipt content.

Similarly, in FIG. 7B, image 720 includes a screen shot 721 of two pie charts. Supplying the corresponding image file, having image 720 encoded therein, as input to an augmentation service as disclosed herein (e.g., augmentation service 103), results in a list of action suggestions 723 that are contextually relevant to the pie chart content.

Similarly, in FIG. 7C, image 730 includes a camera capture 731 of a physical white board with hand-written notes. Supplying the corresponding image file, having image 730 encoded therein, as input to an augmentation service as disclosed herein (e.g., augmentation service 103), results in a list of action suggestions 733 that are contextually relevant to the white board content. Similarly, in FIG. 7D, image 740 includes a screen shot 741 of a data table. Supplying the corresponding image file, having image 740 encoded therein, as input to an augmentation service as disclosed herein (e.g., augmentation service 103), results in a list of action suggestions 743 that are contextually relevant to the data table content.

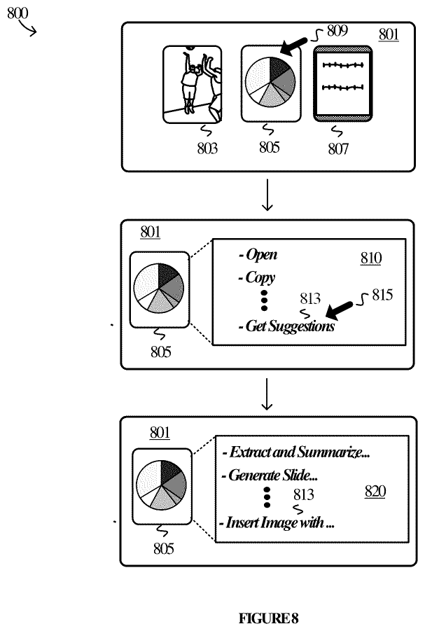

FIG. 8 illustrates a user experience 800 in an implementation the depicts user interactions with some of the images and use cases discussed above. User experience 800 involves user interface 801, which represents the point of interaction between a user and a computer system, software, and/or application. User interface 801 may include visual elements, such as screens, buttons, icons, and menus, as well as the interactive elements, like gestures, commands, and input methods, that allow users to communicate with and control the system. For example, user interface 801 may provide a point of interaction between a user and a photo gallery application, a productivity application (word processing, presentations, etc.), a social media application, a gaming application, a business application, or the like. User interface 801 may be provided by a client application or component running on an underlying computing system or device such as a mobile phone, laptop computer, desktop computer, or the like.

In user experience 800, user interface 801 initially includes thumbnail or preview representations of three image files: file icon 803 corresponding to image 650 in FIG. 6E, file icon 820 corresponding to image 720 in FIG. 7B, and file icon 807 corresponding to image 610 in FIG. 6A. A user may interact with the file icons to cause different actions to be performed. For instance, making a primary selection of a file icon (e.g., by double-clicking, left clicking, or tapping a file icon). Such an action causes the client to send a request to the system to open the full image. The system then locates the associated high-resolution image file, decodes the image data, applies any necessary transformations such as resizing or rotating, and displays the image in an appropriate viewer or interface. The full image may be presented to the user in a dedicated viewer, which may include additional features like zooming, panning, and navigation controls to enhance the viewing experience.

In contrast, a secondary selection of a file icon (e.g., by right-clicking, or pressing and holding an icon) may cause the computing system to surface a context menu that provides additional options for interacting with the image. In user experience 800, a user makes a secondary selection 809 of file icon 805, which causes the client to surface a context menu 810 in user interface 801. Context menus often include various options “Open,” “Save As,” “Copy,” “Paste,” “Properties,” and other relevant actions that allow a user to perform various tasks without navigating through multiple menus or windows. Here, context menu includes at least an Open option, a Copy option, and an option 813 referred to as “Get Suggestions.”

Continuing with user experience 800, a selection 815 of the Get Suggestions option (option 813), causes the client, via the underlying computing system, to obtain actions suggestions relevant to the content in the image from an SLM, via an augmentation service. For instance, if the image is a chart, the augmentation service (in cooperation with an SLM) may suggest actions such as “summarize the chart” or “extract text from the image.” If the image is a handwritten note that contains dates and phone numbers, the augmentation service may return actions such as “extract the dates in the image” or “extract the phone numbers in the image”. The client may then surface the suggested actions in the user interface, allowing the user to select one of them, further causing the client to cooperatively interact with the augmentation service to perform the selected action, including by leveraging capabilities of an LLM.

Here, since file icon 805 relates to pie-chart content, the relevant actions surfaced in context menu 820 include: 1) Extract and summarize key points; 2) Generate slide outline with insights; and 3) Insert this image with generated alternative text. The user may select any of the actions, thereby causing the client to interface with the augmentation service to perform the selected action. For instance, if the user were to select option 813, corresponding to the third suggested action, the client would send a request to the augmentation service to obtain alternative text from an LLM that describes the pie chart in the image, as well as to insert the image into a slide presentation. The augmentation service would cooperatively interact with the LLM to obtain the alternative text, as well as to insert the image into a slide.

In addition, or in an alternative, a prompt autocomplete feature may be enhanced by way of the action suggestion workflow disclosed herein and discussed immediately above. For instance, a user may begin typing or otherwise inputting a prompt in a chat component of a user interface to the augmentation service. The initial text input by the user may be used to trigger the client to request relevant actions from the augmentation service, which when returned, may be surfaced in the chat component as auto-complete suggestions for the user's prompt. In some cases, the user's text may be included in the client's request to the augmentation service (along with the subject image), thereby allowing the augmentation service to include the user's text in its prompt to an SLM for content-relevant actions suggestions. Thus, the action suggestions generated by the SLM may be refined or focused in view of user's initial input.

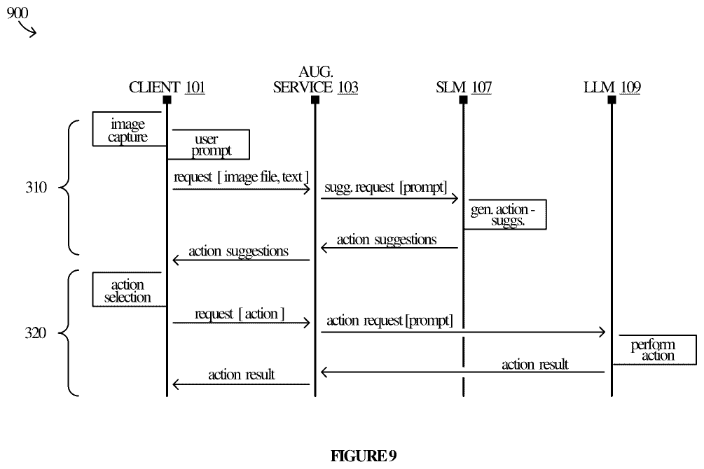

FIG. 9 illustrates operational scenario 900, which briefly depicts the scenario described above with respect to prompt refinements in the context of content augmentation process 200 and the elements and dataflows of system 100 in FIG. 1. In operation, image capture is performed by or in association with client 101. For example, a user operating a client device may capture an image of a physical object such as a paper receipt, take a screenshot of a displayed image, or the like. The image is encoded in image data in accordance with an image file format (e.g., JPEG, PNG, GIF, BMP, and SVG). The user then interacts with client 101 via a user interface to obtain actions suggestions with respect to the image content.

For instance, the user may interact with a chat component of a user interface, including by typing or otherwise inputting user-generated text intended as a prompt to an AI assistant, agent, or the like, to augment the image. The chat component may be a stand-alone component displayed in the user interface independent of the image or file icon associated with the image. Alternatively, the chat component may be surfaced by the user navigating a context menu associated with the file icon and selecting a chat and/or augment option.

The user input may be only a portion of a word, a single (complete) word, or multiple words. For example, the user may type the word “describe,” potentially with the desire for descriptive text to be generated with respect to the content in the image. Client 101 responsively generates an associated request and sends the request to augmentation service 103. The request includes the image file and the user input and is directed to an API of augmentation service 103 that triggers workflow 110.

Augmentation service 103 receives the request and responsively generates a suggestion request for content generation service 105. Augmentation service 103 directs the suggestion request to an API of content generation service 105 corresponding to SLM 107. The suggestion request includes the image file and a prompt that directs SLM 107 to provide action suggestions relevant to the content encoded in the image data of the image file, as well as the text input by the user (e.g., the word “describe”). SLM 107 responds to the API call by processing the image data and user text to generate action suggestions for enhancing or otherwise augmenting the image content in a manner tailored to or focused with respect to the user's prompt. SLM 107 generates the actions suggestions and returns them to augmentation service 103. In turn, augmentation service 103 replies to client 101 with the action-suggestions.

Client 101 receives the action suggestions from augmentation service 103 and displays the suggestions in the user interface on the host computing device. Continuing with the present example where the user typed “describe,” the action suggestions returned by the SLM may include: 1) Describe the added image; 2) Create a description of the areas of the pie chart; and 3) How can I more precisely describe the data reflected in the pie chart? Note that all three action suggestions have the word “describe” in their root and thus are action suggestions tailored to the initial text supplied by the user prompt.

The user operating the device is able to consider the suggestions and select a preferred one from the user interface. Once a suggested action is selected, client 101 communicates a new request to augmentation service 103 that indicates the selected action. In response, augmentation service 103 generates an action request for content generation service 105. The action request is an API call corresponding to LLM 109 and includes both an indication of the selected action and the image file. For instance, the call includes a prompt that directs LLM 109 to perform the selected action with respect to the content in the image file.

LLM 109 responds to the prompt by processing the image file in furtherance of the requested action. In an example, the prompt may task LLM 109 with describing the pie chart in the image, creating a description of the specific sections of the pie chart, and/or providing ideas for more precisely describing the relationships between the areas of the pie chart. LLM 109 performs at least a portion of the requested action and returns the augmented content to augmentations service 103. Augmentation service 103 then provides the results to client 101 for display in its user interface and/or for further processing.

FIG. 10 illustrates computing device 1001 that is representative of any device or collection of devices on which the various processes, programs, services, and scenarios disclosed herein may be implemented. Examples of computing device 1001 include, but are not limited to, server computers, desktop and laptop computers, tablet computers, mobile phones, audio devices, wearable devices (e.g., headphones, ear buds, eyeglasses, and wrist watches), industrial computers, microcontroller units (MCUs), Internet of Things (IoT) devices, and the like.

Computing device 1001 may be implemented as a single apparatus, system, or device or may be implemented in a distributed manner as multiple apparatuses, systems, or devices. Computing device 1001 includes, but is not limited to, processing system 1002, storage system 1003, software 1005, communication interface system 1007, and user interface system 1009. Processing system 1002 is operatively coupled with storage system 1003, communication interface system 1007, and user interface system 1009.

Processing system 1002 loads and executes software 1005 from storage system 1003. Software 1005 includes and implements process 1006, which is representative of the processing methods and processes described above such as content augmentation process 200 and training process 400. When executed by processing system 1002, software 1005 directs processing system 1002 to operate as described herein for at least the various processes, operational scenarios, and sequences discussed in the foregoing implementations. Computing device 1001 may optionally include additional devices, features, or functionality not discussed for purposes of brevity.

Referring still to FIG. 10, processing system 1002 may comprise a micro-processor and other circuitry that retrieves and executes software 1005 from storage system 1003. Processing system 1002 may be implemented within a single processing device but may also be distributed across multiple processing devices or sub-systems that cooperate in executing program instructions. Examples of processing system 1002 include general purpose central processing units (CPUs), graphical processing units (GPUs), neural processing units (NPUs), digital signal processors (DSPs), application specific integrated circuits (ASICs), and logic devices, as well as any other type of processing device, circuitry, or combinations and variations thereof.

Storage system 1003 may comprise any computer readable storage media readable by processing system 1002 and capable of storing software 1005. Storage system 1003 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 1003 may also include computer readable communication media over which at least some of software 1005 may be communicated internally or externally. Storage system 1003 may be implemented as a single storage device but may also be implemented across multiple storage devices or sub-systems co-located or distributed relative to each other. Storage system 1003 may comprise additional elements, such as a controller, capable of communicating with processing system 1002 or possibly other systems.

Software 1005 (including process 1006) may be implemented in program instructions and among other functions may, when executed by processing system 1002, direct processing system 1002 to operate as described with respect to the various operational scenarios, sequences, and processes illustrated herein. For example, software 1005 may include program instructions for implementing the inference and training processes described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1005 may include additional processes, programs, or components, such as operating system software, virtualization software (including virtual machine software and container software), or other such application software. Software 1005 may also comprise firmware or some other form of machine-readable processing instructions executable by processing system 1002.

In general, software 1005 may, when loaded into processing system 1002 and executed, transform a suitable apparatus, system, or device (of which computing device 1001 is representative) overall from a general-purpose computing system into a special-purpose computing system customized to perform content augmentation and/or model training in an optimized manner. Indeed, encoding software 1005 on storage system 1003 may transform the physical structure of storage system 1003. The specific transformation of the physical structure may depend on various factors in different implementations of this description. Examples of such factors may include, but are not limited to, the technology used to implement the storage media of storage system 1003 and whether the computer-storage media are characterized as primary or secondary storage, as well as other factors.

For example, if the computer readable storage media are implemented as semiconductor-based memory, software 1005 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1007 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 1001 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A method comprising:
by one or more computing devices:
sending a first request to a content generation service to obtain action suggestions relevant to content encoded in an image file, wherein the first request includes a first prompt that tasks a small language model of the content generation service with generating the action suggestions based at least on the content in the image file;
receiving the suggested actions from the content generation service and responsively enabling display of the suggested actions in a user interface;
receiving an indication of a selected one of the action suggestions; and
sending a second request to the content generation service to perform an action corresponding to the selected one of the action suggestions, wherein the second request comprises a second prompt that tasks a large language model of the content generation service with performing at least a portion of the action.

2. The method of claim 1 further comprising training the small language model based on training data, wherein the training data comprises training image files and, for each training image file of the training image files, action labels indicative of known actions associated with content encoded in the training image file, and further indicative of additional actions generated by one or more large language models based at least on the training image file and the known actions.

3. The method of claim 2 wherein the small language model comprises an artificial neural network, and wherein training the small language model comprises:
generating feature vectors based on image data in the training image files;
supplying the feature vectors as input to the neural network to obtain predicted actions as outputs; and
modifying weights of the neural network based on comparisons of the predicted actions to the action labels for each of the training image files.

4. The method of claim 2 wherein the method further comprises generating the training data including by, for each one of the training image files:
identifying target content encoded in the training image file;
classifying a type of the target content in the training image file; and
determining the known actions based on the type of the target content.

5. The method of claim 4 wherein generating the training data further comprises, for each of the training image files, generating and sending a prompt to one or more large language models to identify the additional actions based at least on the known actions determined for the training image.

6. The method of claim 1 wherein the content includes a data table, and wherein the suggested actions include generating a corresponding table in a spreadsheet, creating a chart based on values in the data table, and summing numbers in each column of the data table.

7. The method of claim 1 wherein the content includes a phone number, and wherein the suggested actions include initiating a call using the phone number, creating a new contact with the phone number, and sending a text message to the phone number.

8. One or more computer readable storage media having program instructions stored thereon that, when executed by one or more processors of a computing apparatus, direct the computing apparatus to at least:
send a first request to a content generation service to obtain action suggestions relevant to content encoded in an image file, wherein the first request includes a first prompt that tasks a small language model of the content generation service with generating the action suggestions based at least on the content in the image file;
enable display of the suggested actions in a user interface; and
send a second request to the content generation service to perform an action corresponding to a selected one of the action suggestions, wherein the second request comprises a second prompt that tasks a large language model of the content generation service with performing at least a portion of the action.

9. The one or more computer readable storage media of claim 8 wherein the program instructions further direct the computing apparatus to receive, from a client, an initial request for the suggested actions, wherein the initial request includes the image file.

10. The one or more computer readable storage media of claim 9 wherein, to enable the display of the suggested actions in the user interface, the program instructions direct the computing apparatus to send the suggested actions to the client.

11. The one or more computer readable storage media of claim 10 wherein the client is hosted locally on the computing apparatus and the small language model is hosted locally on the computing apparatus.

12. The one or more computer readable storage media of claim 8 wherein the program instructions further direct the computing apparatus to generate the first prompt and to generate the second prompt.

13. The one or more computer readable storage media of claim 8 wherein the content includes a data table, and wherein the suggested actions include generating a corresponding table in a spreadsheet, creating a chart based on values in the data table, and summing numbers in each column of the data table.

14. The one or more computer readable storage media of claim 8 wherein the content includes a phone number, and wherein the suggested actions include initiating a call using the phone number, creating a new contact with the phone number, and sending a text message to the phone number.

15. The one or more computer readable storage media of claim 8 wherein the image file comprises image data having a visual image of the content encoded therein, wherein the content includes one or more objects, one or more entities, or both, and wherein the suggested actions comprise capabilities of the large language model relevant to the content.

16. A computing apparatus comprising:
one or more computer readable storage media;
one or more processors operatively coupled with the one or more computer readable storage media; and
program instructions stored one the one or more computer readable storage media that, when executed by the one or more processors, direct the computing apparatus to at least:
send a first request to a content generation service to obtain action suggestions relevant to content encoded in an image file, wherein the first request includes a first prompt that tasks a small language model of the content generation service with generating the action suggestions based at least on the content in the image file;
enable display of the suggested actions in a user interface; and
send a second request to the content generation service to perform an action corresponding to a selected one of the action suggestions, wherein the second request comprises a second prompt that tasks a large language model of the content generation service with performing at least a portion of the action.

17. The computing apparatus of claim 16 wherein the program instructions further direct the computing apparatus to receive, from a client, an initial request for the suggested actions, wherein the initial request includes the image file, and wherein, to enable the display of the suggested actions in the user interface, the program instructions direct the computing apparatus to send the suggested actions to the client.

18. The computing apparatus of claim 17 wherein the client is hosted locally on the computing apparatus and the small language model is hosted locally on the computing apparatus, and wherein the program instructions further direct the computing apparatus to generate the first prompt and to generate the second prompt.

19. The computing apparatus of claim 16 wherein the content includes a data table, and wherein the suggested actions include generating a corresponding table in a spreadsheet, creating a chart based on values in the data table, and summing numbers in each column of the data table.

20. The computing apparatus of claim 16 wherein the content includes a phone number, and wherein the suggested actions include initiating a call using the phone number, creating a new contact with the phone number, and sending a text message to the phone number.
